(19) United States
(12) Patent Application Publication
(10) Pub. No.: US 2026/0027847 A1
(43) Pub. Date: Jan. 29, 2026

(54) IDENTIFICATION DOCUMENT PERSONALIZATION SYSTEM WITH CURING CONTROL

(71) Applicant: ENTRUST CORPORATION, SHAKOPEE, MN (US)

(72) Inventors: Jon WAWRA, Shakopee, MN (US); Cory WOOLDRIDGE, Shakopee, MN (US); Tim FLITSCH, Shakopee, MN (US)

(21) Appl. No.: 19/269,965

(22) Filed: Jul. 15, 2025

Related U.S. Application Data
(60) Provisional application No. 63/676,051, filed on Jul. 26, 2024.

(51) Int. Cl. B41M 7/00; B41J 3/407; B41J 3/54; B41J 11/00; B41M 3/00; B41M 3/14; B41M 5/00; B42D 25/23

(52) U.S. Cl. CPC B41M 7/0081; B41J 3/407; B41J 3/543; B41J 11/00212; B41J 11/00214; B41J 11/00218; B41M 3/005; B41M 3/008; B41M 3/14; B41M 5/0047; B41M 5/0064; B42D 25/23

(57) ABSTRACT

Identification document personalization systems and methods that use a cure lamp to both pin (i.e. partially cure) radiation curable material printed on the surface of an identification document and completely or fully cure radiation curable material printed on the surface of the identification document. This eliminates the need to have both a pinning lamp and a cure lamp, which reduces the cost and complexity of the system and reduces the cost of the system.

### PRIORITY

This application claims the benefit of U.S. Provisional Application Ser. No. 63/676,051 filed on Jul. 26, 2024, the entire contents of which are incorporated herein by reference.

### FIELD

This technical disclosure relates to printing curable materials on identification documents such as cards including, but not limited to, identification cards, driver's licenses, financial cards including credit and debit cards, and other cards, as well as passports and pages thereof.

### BACKGROUND

The use of radiation curable materials to print images, patterns and text on identification documents is known. Once the radiation curable material is cured, the durability of the printed material is enhanced. A card personalization system that prints radiation curable materials often includes one or more pinning lamps configured to partially cure radiation curable material printed on the identification document prior to full or complete curing, as well as a cure lamp that fully or completely cures the printed radiation curable material.

### SUMMARY

Identification document personalization systems and methods are described herein that use a cure lamp to both pin (i.e. partially cure) radiation curable material printed on the surface of an identification document and completely or fully cure radiation curable material printed on the surface of the identification document. This eliminates the need to have both a pinning lamp and a cure lamp, which reduces the cost and complexity of the system and reduces the cost of the system.

As used herein, the word “pin” or “pinning” or the like refers to partial or incomplete curing of the radiation curable material, while “completely cure”, “fully cure” or the like refers to an extent of curing of the radiation curable material that is more than pinning and that is considered complete or full. The word “cure” used by itself (i.e. without the word partial, incomplete, completely, partially, etc.) should be considered to encompass both partial or incomplete curing and complete or full curing.

In an embodiment, shutters can be used to restrict radiation emitted by the cure lamp from reaching the radiation curable material printed on the surface of the identification document during pinning of the radiation curable material using the cure lamp. When the radiation curable material needs to be completely cured, the shutters can be controlled so that radiation emitted by the cure lamp can achieve complete or full curing. In another embodiment, the power of the cure lamp is controlled to adjust the radiation level emitted by the cure lamp, with the cure lamp being controlled to have a pinning level that emits radiation suitable for pinning and controlled to have a curing level that emits radiation suitable for complete curing.

The printing of the radiation curable material described herein can be achieved using any printing technique suitable for printing radiation curable material on an identification document. For example, the printing can be drop-on-demand (DOD) printing, or thermal transfer printing that prints radiation curable material, such as radiation curable ink, from a thermal transfer print ribbon onto an identification document. An example of DOD printing with a radiation curable material in a card personalization system is described in U.S. Pat. No. 10,049,320 which is incorporated herein by reference in its entirety. An example of thermal printing a radiation curable material from a print ribbon is described in U.S. Pat. No. 10,889,129 which is incorporated herein by reference in its entirety.

The identification document can be a card which may be made entirely of plastic, or a combination of plastic and non-plastic materials, or made entirely of non-plastic materials such as paper or metal. Examples of identification documents include, but not limited to, an identification card, a driver's license, a financial card including a credit and debit card, a gift card, and other plastic cards, or a page of a passport or other identification booklet.

In one example implementation, an identification document printing method in an identification document personalization system can include printing on a surface of an identification document with a radiation curable material, partially curing the radiation curable material in a curing station by applying curing radiation from a cure lamp of the curing station to the radiation curable material, thereafter printing on the surface of the identification document with additional radiation curable material, and thereafter fully curing the radiation curable material and the additional radiation curable material in the curing station by applying curing radiation from the cure lamp.

The partial curing can comprise using shutters in the curing station to control the amount of curing radiation emitted by the cure lamp from reaching the radiation curable material on the surface.

In another embodiment, a first amount of curing radiation can be emitted from the cure lamp during the partial curing and a second amount of curing radiation can be emitted from the cure lamp during the full curing, with the first amount being less than the second amount. The curing radiation may be any radiation, such as ultraviolet radiation, that is suitable for achieving the partial or full curing of the radiation curable material, and the cure lamp may comprise at least one light emitting diode or other lamp that emits curing radiation.

The radiation curable materials that can be printed include, but are not limited to, one or more inks, one or more varnishes, and any other radiation curable material that can be printed on identification documents.

In another example implementation, an identification document printing method in an identification document personalization system can include printing on a surface of an identification document with a radiation curable material, partially curing the radiation curable material in a curing station by emitting a first level of curing radiation from a cure lamp of the curing station, thereafter printing on the identification document surface with additional radiation curable material, and thereafter fully curing the radiation curable material and the additional radiation curable material in the curing station by emitting a second level of curing radiation from the cure lamp of the curing station, where the second level is greater than the first level.

In another example implementation, an identification document personalization system can include a document input that inputs an identification document to be personalized, an identification document printing mechanism downstream from the document input and configured to print radiation curable material on a surface of the identification document, a curing station having at least one cure lamp, and a document output that receives the identification document after being personalized. A control system is connected to and configured to control operation of the identification document printing mechanism and the curing station. The control system is configured to control the identification document printing mechanism to print a first radiation curable material on the surface of the identification document, control the curing station to partially cure the first radiation curable material by applying curing radiation from the at least one cure lamp to the first radiation curable material, thereafter control the identification document printing mechanism to print additional radiation curable material on the surface of the identification document, and thereafter control the curing station to fully cure the first radiation curable material and the additional radiation curable material in the curing station by applying curing radiation from the at least one cure lamp.

The identification document printing mechanism may comprise at least one drop-on-demand print head, or a plurality of drop-on-demand print heads. The at least one cure lamp may comprise at least one light emitting diode. In one implementation, the identification document printing mechanism and the curing station are positioned between the document input and the document output. In another implementation, the identification document printing mechanism and the curing station may be positioned downstream from both the document input and the document output. Other relative positions between the identification document printing mechanism, the curing station, the document input and the document output are also possible.

### DRAWINGS

FIG. 1 is an example of an identification document printing method described herein.

FIG. 2 is another example of an identification document printing method described herein.

FIG. 3 depicts an example of an identification document in the form of a card.

FIG. 4 depicts an example of shutters controlling the amount of radiation reaching the identification document.

FIG. 5 illustrates an example of a shutter control mechanism.

FIG. 6 illustrates another example of a shutter control mechanism.

FIG. 7 depicts an example of controlling the radiation emitted by the cure lamp.

FIG. 8 depicts an example of an identification document personalization system that can utilize the techniques described herein.

FIG. 9 depicts another example of an identification document personalization system that can utilize the techniques described herein.

FIG. 10 depicts another example of an identification document personalization system that can utilize the techniques described herein.

FIG. 11 depicts another example of an identification document personalization system that can utilize the techniques described herein.

### DETAILED DESCRIPTION

Identification document personalization systems and methods are described where a single curing station is used to both pin (i.e. partially cure) radiation curable material printed on the surface of an identification document as well as completely or fully cure radiation curable material printed on the surface of the identification document. The identification document can be any identification document having personalization of the intended document holder applied thereto and which is then issued to the intended document holder. Examples of identification documents include, but are not limited to, identification cards, driver's licenses, financial cards including credit and debit cards, and other plastic cards, or a page of a passport or other identification booklet.

The identification document can be a card which may be made entirely of plastic, or a combination of plastic and non-plastic materials, or entirely of non-plastic materials such as paper or metal. In an embodiment, the card may be made of a plastic such as polycarbonate. In an embodiment, the cards may be ID-1 cards as defined by ISO/IEC 7810. However, other card formats such as ID-2 as defined by ISO/IEC 7810 are possible as well. The passport pages can be a front cover or a rear cover of the passport, or an internal page (for example a plastic page referred to as a data page) of the passport. In an embodiment, the passports may be in an ID-3 format as defined by ISO/IEC 7810. For simplicity, the following examples may refer to the identification document as a plastic card or a card. However, the following examples, and the concepts described in this patent application, can be applied to other identification documents as well.

The term “personalization” (or the like) as used throughout the specification and claims, unless indicated otherwise, is intended to encompass operations performed on an identification document that includes operations that result in personalizing the identification document as well as operations that do not result in personalizing the identification document. An example of a personalization operation that personalizes the identification document is printing the intended document holder's image or name on the identification document. An example of a personalization operation that does not personalize the identification document is printing non-identification document holder graphics on the identification document. The term “personalize” is often used in the personalized identification document industry to refer to an identification document, such as a card, that undergoes both personalization processing operations and non-personalization processing operations.

As used herein, the word “step” includes a single action within the step or multiple actions within the step.

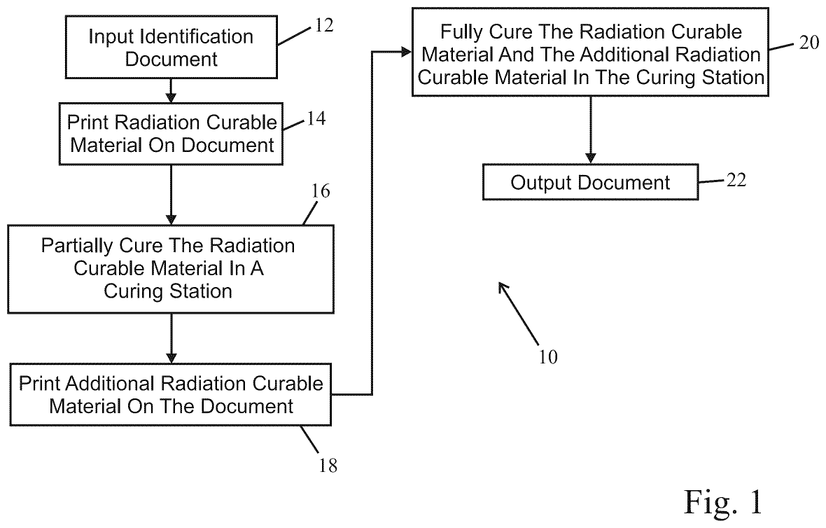

Referring to FIG. 1, an example of an identification document printing method 10 is illustrated. In a step 12, a card (or other identification document) is input into identification document personalization system. The card may be input from an input hopper that is configured to contain one or more additional cards, or the card may be manually input via an input slot. The construction and operation of input hoppers and input slots in identification document personalization systems is well known in the art. The card is then transported to an identification document printing mechanism that is configured to print radiation curable material on a surface of the card. Transport of the card is achieved using suitable transport mechanisms known in the art including rollers, belts, tabbed belts, and combinations thereof. The transport mechanisms may be configured to transport the card in a single, forward direction, or the transport mechanisms may be reversible to transport the card in forward and reverse directions. Card and other document transport mechanisms in identification document personalization systems are well known in the art including those disclosed in U.S. Pat. Nos. 6,902,107, 5,837,991, 6,131,817, and 4,995,501 and U.S. Published Application Nos. 2013/0220984 and 2018/0326763, each of which is incorporated herein by reference in its entirety. A person of ordinary skill in the art would readily understand the type(s) of document transport mechanisms that could be used, as well as the construction and operation of such document transport mechanisms.

In step 14, radiation curable material is then printed on the card using the printing mechanism. The printing mechanism can be configured to print using any printing technique suitable for printing radiation curable material on a card. For example, the printing mechanism can be configured to perform DOD printing from one or more DOD print heads, or configured to perform thermal transfer printing from one or more thermal transfer print ribbons using one or more thermal transfer print heads. An example of DOD printing mechanism that prints radiation curable material in a card personalization system is described in U.S. Pat. No. 10,049,320 which is incorporated herein by reference in its entirety. An example of a thermal transfer printing mechanism that performs thermal transfer printing of a radiation curable material from a print ribbon using a thermal print head is described in U.S. Pat. No. 10,889,129 which is incorporated herein by reference in its entirety.

The radiation curable material that is printed onto the card can be any material that is curable by the application of radiation, for example ultra-violet (UV) radiation, to the printed material after it is applied to the surface of the card. The radiation curable material printed by the printing mechanism may be one or more of ink, varnish, and any other radiation curable materials that can be applied to cards. In the case of ink, the ink may be a single color (i.e. monochromatic) or multiple colors of ink such as cyan, magenta, yellow and black (CMYK) inks. In the case of varnish, the varnish may be transparent or semi-transparent, and may be applied over previously applied ink.

After printing, the printed radiation curable material is partially cured in a curing station in step 16. In an embodiment, between steps 14 and 16, the card may be transported from the printing mechanism to the curing station. The curing station may be a mechanism that is separate from the printing mechanism, or the curing station may be incorporated into and considered part of the printing mechanism. An example of a curing station in a card personalization system is described in U.S. 2021/0086530, the entire contents of which are incorporated herein by reference, or available from Entrust Corporation of Shakopee, Minnesota.

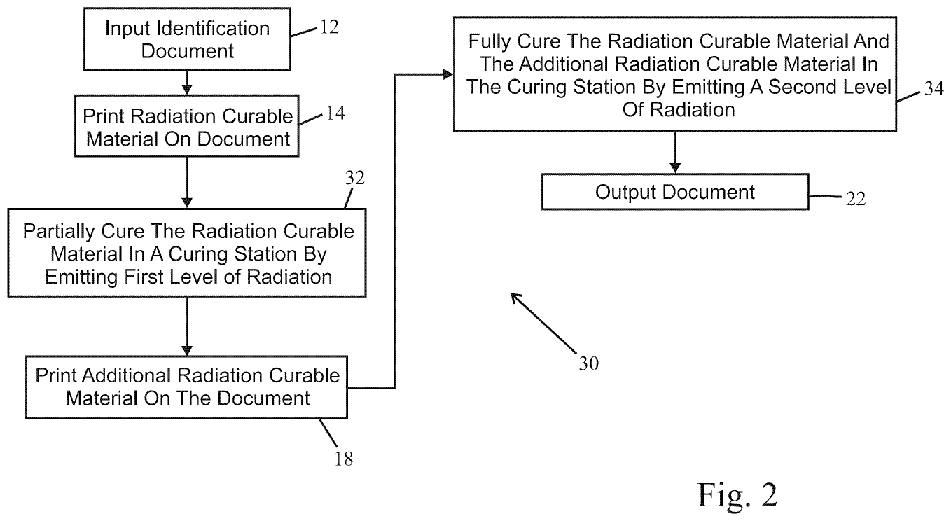

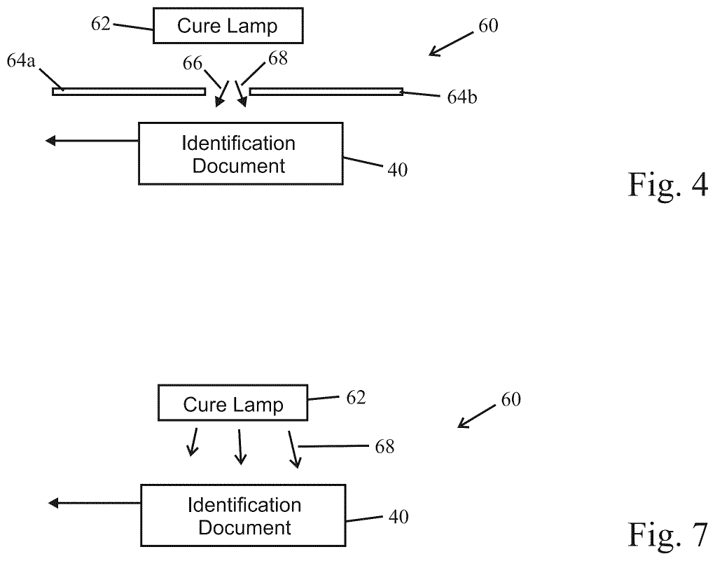

The partial curing in step 16 may be achieved using any curing technique that is suitable to achieve partial curing. For example, the partial curing may be achieved using shutters as described below with respect to FIGS. 4-6 or by controlling the output of one or more cure lamps of the curing station as described below with respect to FIGS. 2 and 7.

After step 16, additional radiation curable material is printed on the card in step 18. The printing of the additional radiation curable material may be achieved using the same printing mechanism used in step 14 or achieved using a second, additional printing mechanism. Examples of how to utilize the same printing mechanism in step 18, and how to utilize a second, additional printing mechanism in step 18, are described below. If a second, additional printing mechanism is used, the printing performed by the second, additional printing mechanism may be any printing technique suitable for printing radiation curable material on a card, for example DOD printing from one or more DOD print heads, or thermal transfer printing from one or more thermal transfer print ribbons using one or more thermal transfer print heads. The second, additional printing mechanism, if present, may be configured to perform a printing technique that differs from the printing technique used by the printing mechanism in step 14.

After the printing in step 18, the additional printed radiation curable material from step 18 and the partially cured radiation curable material from step 16 is fully or completely cured in step 20 using the curing station that was used in step 16. In an embodiment, between steps 18 and 20, the card may be transported from the printing mechanism used in step 18 back to the curing station. The full or complete curing in step 20 may be achieved using the shutters as described below with respect to FIGS. 4-6 or by controlling the output of one or more cure lamps of the curing station as described below with respect to FIGS. 2 and 7.

After step 20, the card is output from a document output in step 22. The card may be transported to the document output after step 20. The document output may be an output hopper that is configured to contain one or more additional personalized cards, or the document output may be an output slot. The construction and operation of output hoppers and output slots in identification document personalization systems is well known in the art.

The method 10 may also include additional card processing steps. For example, between steps 12 and 14, a magnetic stripe on the card may be encoded in a read/write system that is configured to read data from and/or write data to the magnetic stripe on the card, and/or an integrated circuit chip on the card may be programmed using an integrated circuit chip programming system. Magnetic stripe read/write systems and integrated circuit chip programming systems are disclosed, for example, in U.S. Pat. Nos. 6,902,107 and 6,695,205 the entire contents of which are incorporated herein by reference, and can be found in the MX family of central issuance systems available from Entrust Corporation of Shakopee, Minnesota. Additional processing between steps 12 and 14 may also include, but are not limited to, embossing; indenting; laminating; laser marking; applying a topcoat; a security station that is configured to apply a security feature such as a holographic foil patch to the card; and other card processing operations. In another example, additional processing may also occur between steps 20 and 22. Additional processing between steps 20 and 22 may also include, but are not limited to, embossing; indenting; laminating; laser marking; applying a topcoat; a quality control station that is configured to check the quality of personalization/processing applied to the card; a security station that is configured to apply a security feature such as a holographic foil patch to the card; and other card processing operations.

Referring to FIG. 2, another example of an identification document printing method 30 is illustrated. In the method 30, steps that are similar or identical to steps in the method 10 are referenced using the same reference numerals. In one embodiment, the steps 12, 14, 18 and 22 in the method 30 are the same as the steps 12, 14, 18 and 22 in the method 10 and may be performed using the same mechanisms described above.

The method 30 differs from the method 10 in that in step 32, the printed radiation curable material is partially cured by controlling a cure lamp(s) of the curing station to emit a first level of radiation that is suitable for achieving the partial curing as described in more detail below with respect to FIG. 7. In an embodiment, between steps 14 and 32, the card may be transported from the printing mechanism to the curing station. The curing station may be a mechanism that is separate from the printing mechanism, or the curing station may be incorporated into and be considered part of the printing mechanism. An example of a curing station in a card personalization system is described in U.S. 2021/0086530, the entire contents of which are incorporated herein by reference, or available from Entrust Corporation of Shakopee, Minnesota.

In addition, the method 30 differs from the method 10 in that in step 34, the additional printed radiation curable material from step 18 and the partially cured radiation curable material from step 32 is fully or completely cured using the curing station that was used in step 32. However, in step 34, the cure lamp(s) of the curing station is controlled to emit a second level of radiation that is greater than the first level of radiation used in step 32 with the second level of radiation being sufficient to achieve complete or full curing as described below in further detail in FIG. 2. In an embodiment, between steps 18 and 34, the card may be transported from the printing mechanism used in step 18 back to the curing station.

Similar to the method 10, the method 30 may also include additional card processing steps, including additional processing between the steps 12 and 14 and between the steps 34 and 22. The additional processing in the method may be the additional processing described above for the method 10.

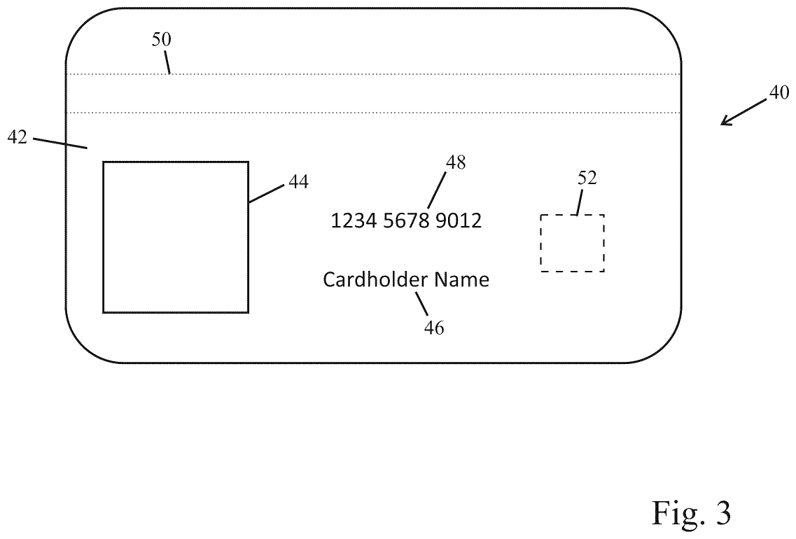

FIG. 3 illustrates an example of an identification document in the form of a card 40 which may be referred to as a plastic card. The card 40 may be an identification card, a driver's license, a financial card including a credit and debit card, a gift card, and other personalized cards. The card 40 is depicted as including a surface 42 which may be referred to and considered as a front surface of the card. In this example, the surface 42 is the surface that is intended to be printed on. The printing can include a printed image (i.e. a portrait image) 44 of the intended holder of the card 40, where the printed image can be a monochromatic image or a multicolor image for example printed from CMYK inks, the name 46, address and other personal data of the intended card holder, or a document number such as an account number 48. The card 40 can further include additional personal data provided on the surface 42 and/or provided on an opposite surface such as a CVV number. The additional personal data may be printed onto the card 40 using the same print mechanisms described above and/or using other known printing techniques, for example retransfer printing, laser marking, and other printing techniques known in the art of card processing. In the case of the card 40 depicted in FIG. 3, the card 40 may also include a magnetic stripe 50 (often disposed on the surface that is opposite the surface 42) that can be magnetically encoded with data. The card 40 may also include an integrated circuit chip 52 that can be electronically programmed with data.

Referring to FIGS. 4-6, the curing (both partial curing and full or complete curing) described herein can be achieved using a curing station 60 that includes one or more cure lamps 62 that emits curing radiation with the amount of radiation that reaches the card 40 being controlled by one or more shutters 64a, 64b. The one or more cure lamps may be one or more light emitting diodes. The use of shutters in a curing station of an identification document personalization station is disclosed in U.S. Pat. No. 11,858,257 the entire contents of which are incorporated herein by reference.

In the illustrated embodiment, the shutters 64a, 64b can be controlled to move toward and away from one another to control the size of an aperture 66 between facing ends of the shutters which controls the amount of radiation 68 emitted by the cure lamp 62(s) that reaches the card 40 for curing (partial or full) the radiation curing material. By controlling the size of the aperture 66, thereby controlling the amount of radiation that reaches the card 40, the radiation curable material printed onto the card 40 can be partially cured or fully/completely cured. Both shutters 64a, 64b may be movable, or one shutter can be fixed while the other shutter is movable to control the size of the aperture 66. In another embodiment, rather than controlling the size of the aperture 66 between the shutters 64a, 64b, a single shutter could be used that has a controllable aperture/iris to allow control of the aperture/iris size and therefore control the amount of radiation that is allowed through the aperture.

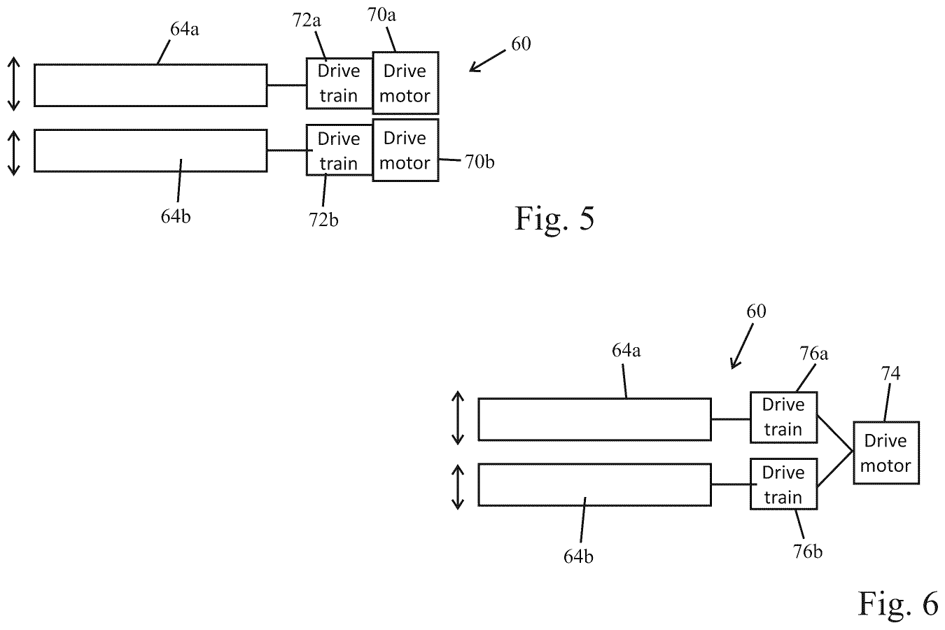

Referring to FIGS. 5 and 6, examples of actuating the shutters 64a, 64b are depicted. With reference to FIG. 5, in one embodiment, the first movable shutter 64a can be driven back and forth in the direction of the arrow via dedicated drive motor 70a and drive train 72a, while the second movable shutter 64b can be driven back and forth in the direction of the arrow via dedicated drive motor 70b and drive train 72b. In another embodiment, with reference to FIG. 6, the movable shutters 64a, 64b can share a common drive motor 74 that drives separate drive trains 76a, 76b which separately and independently drive the movable shutters 64a, 64b. In another embodiment, the shutters 64a, 64b can be driven using a common drive train and a single common drive motor. The drive motors 70a, 70b, 74 and the drive trains 70a, 70b, 76a, 76b can have any construction suitable for driving the movable shutters 64a, 64b back and forth in the indicated directions. For example, the drive motors can be stepper motors and the drive trains can include elements such as pulleys, drive belts and gears.

Referring to FIG. 7, in an embodiment the power level of the cure lamp(s) 62 can be controlled to control the amount of radiation 68 that is emitted by the cure lamps(s) and thereby control the amount of curing (partial curing and full or complete curing) that takes place. The power level of the cure lamp(s) maybe controlled by a suitable control system, for example a control system of the identification document personalization system that the curing station 60 is incorporated into, or a control system that is dedicated to the curing station 60. For example, when partial curing is desired, the cure lamp(s) 62 can be controlled to emit a first level of radiation 68 that is suitable to achieve the partial curing. When full or complete curing is desired, the cure lamp(s) 62 can be controlled to emit a second level of radiation 68, which is greater than the first level of radiation, that is suitable to achieve the full or complete curing.

In an embodiment, both use of the shutters in the embodiment of FIGS. 4-6 and control of the power level of the cure lamp(s) 62 in the embodiment in FIG. 7 can be used to control the radiation that reaches the card to achieve the partial curing and the subsequent full or complete curing.

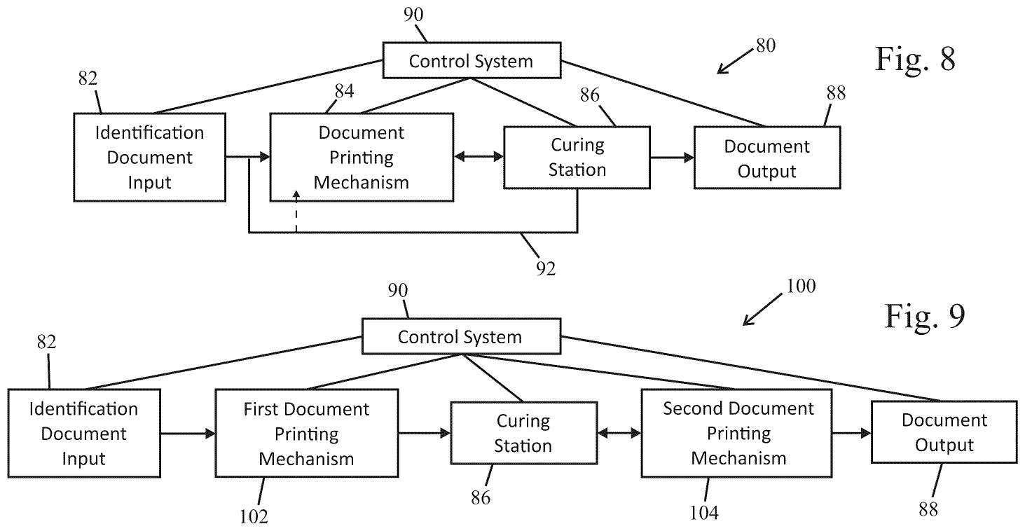

Referring to FIG. 8, an example of an identification document personalization system 80 that can implement the methods 10, 30 described in FIGS. 1-2 is illustrated. The system 80 is depicted as including a document input 82, a printing mechanism 84, a curing station 86, a document output 88, and a control system 90.

The document input 82 may be configured to hold a plurality of cards or other identification documents waiting to be processed and to input each card one-by-one for subsequent processing. Alternatively, the document input may be an input slot through which an individual card is manually fed into the system 80.

The printing mechanism 84 may be configured to perform DOD printing using one or more DOD print heads, thermal transfer printing using a thermal transfer print ribbon and a thermal print head, or perform other printing that may be suitable for printing radiation curable materials to a card or other identification document surface. The printing mechanism 84 is considered downstream from the input 82, located between the input 82 and the output 88, and located between the input 82 and the curing station 86. In an embodiment, in the case of DOD printing, the system 80 may optionally include a plasma treatment station (not illustrated) that is positioned in the system 80 so as to be able to plasma treat the surface of the card prior to DOD printing. For example, the plasma treatment station can be located upstream of the printing mechanism 84 between the input 82 and the printing mechanism 84.

The curing station 86 may be configured similar to the curing station 60 described above for FIGS. 4-7 with at least one cure lamp, and one or more shutters and/or control of the one or more cure lamps as described above. The curing station 86 is considered downstream from the input 82, located between the input 82 and the output 88, and located between the printing mechanism 84 and the output 88.

The document output 88 is depicted as being located at the end of the processing line of the system 80. The output 88 may be configured to hold a plurality of the cards after processing has been completed. Alternatively, the document output 88 may be an output slot through which an individual card is output from the system 80.

The control system 90 is connected to and controls operation of the input 82, the printing mechanism 84, the curing station 86 and the output 88. The control system 90 may also receive electronic feedback signals from one or more of the input 82, printing mechanism 84, curing station 86 and the output 88. The control system 90 may integrated into and be physically part of the system 80. Alternatively, the control system 90 may be physically separate from the system 80, but suitably connected to the system 80 to be able to control at least the printing mechanism 84 and the curing station 86.

In the system 80, the card generally travels in a direction from the input 82 to the printing mechanism 84, to the curing station 86 and then to the output 88. However, FIG. 8 illustrates a recirculation path 92 that is configured to recirculate a card back to or upstream of the printing mechanism 84 to perform the additional printing in step 18 of the method 10 (FIG. 1) and the step 18 of the method 30 (FIG. 2). After the partial curing in the curing station 86, the card is recirculated back along the recirculation path 92 to direct the card back through the printing mechanism 84 to perform the additional printing in step 18 (FIGS. 1 and 2). An example of a card personalization system with a card recirculation path is described in U.S. Pat. No. 10,049,320 which is incorporated herein by reference in its entirety. Alternatively to or in addition to the recirculation path 92, the transport mechanism between the curing station 86 and the printing mechanism 84 may be reversible so that after the partial curing in the cure station 86, the card is transported in reverse back into the printing mechanism 84 to perform the additional printing, with the card then being transported back into the curing station 86 to perform the full or complete curing.

The control system 90 is configured to control the printing mechanism 84 to print the first radiation curable material on the surface of the card, control the curing station 86 to partially cure the first radiation curable material by applying curing radiation from the at least one cure lamp to the first radiation curable material, thereafter control transport of the card back to the printing mechanism 84 via the recirculation path 92 or reversing the card from the curing station 86 back into the printing mechanism 84, control the printing mechanism 84 to print the additional radiation curable material on the surface of the card, control transport of the card back into the curing station 86 and thereafter control the curing station 86 to fully cure the first radiation curable material and the additional radiation curable material in the curing station 86.

Referring to FIG. 9, another example of an identification document personalization system 100 that can implement the methods 10, 30 described in FIGS. 1-2 is illustrated. In FIG. 9, elements that are the same as or similar to elements in FIG. 8 are referenced using the same reference numerals. In FIG. 9, the system 100 includes a first printing mechanism 102 and a second printing mechanism 104. The first printing mechanism 102 may have a construction and operation that is similar to the printing mechanism 84 in the system 80 of FIG. 8. The second printing mechanism 104 may also have a construction and operation that is similar to the printing mechanism 84 in the system 80 of FIG. 8. However, the construction and operation of the printing mechanisms 102, 104 may differ from one another. For example, the printing mechanism 102 (or the printing mechanism 104) may be configured for DOD printing while the printing mechanism 104 (or the printing mechanism 102) may be configured for thermal transfer printing. Alternatively, the printing mechanism 102 (or the printing mechanism 104) may be configured for multi-color DOD printing while the printing mechanism 104 (or the printing mechanism 102) may be configured for monochromatic DOD printing.

In FIG. 9, by including the second printing mechanism 104, the need for the recirculation path 92 of FIG. 8 is eliminated. Instead, in the system 100, the first printing in step 14 of the methods 10, 30 in FIGS. 1-2 can be performed using the first printing mechanism 102, while the second or additional printing in step 18 of the methods 10, 30 can be performed using the second printing mechanism 104. As depicted by the double-headed arrows between the curing station 86 and the second printing mechanism 104 in FIG. 9, the transport mechanism between the curing station 86 and the second printing mechanism 104 is reversible so that after the printing in the second printing mechanism 104, the card is transported in reverse back into the curing station 86 to perform the full or complete curing, with the card then being transported back through the second printing mechanism 104 to the output 88.

With the system 100 of FIG. 9, the control system 90 is configured to control the first printing mechanism 102 to print the first radiation curable material on the surface of the card, control the curing station 86 to partially cure the first radiation curable material by applying curing radiation from the at least one cure lamp to the first radiation curable material, thereafter control the second printing mechanism 104 to print the additional radiation curable material on the surface of the card, control transport of the card back into the curing station 86 by reversing the travel of the card, and thereafter control the curing station 86 to fully cure the first radiation curable material and the additional radiation curable material in the curing station 86.

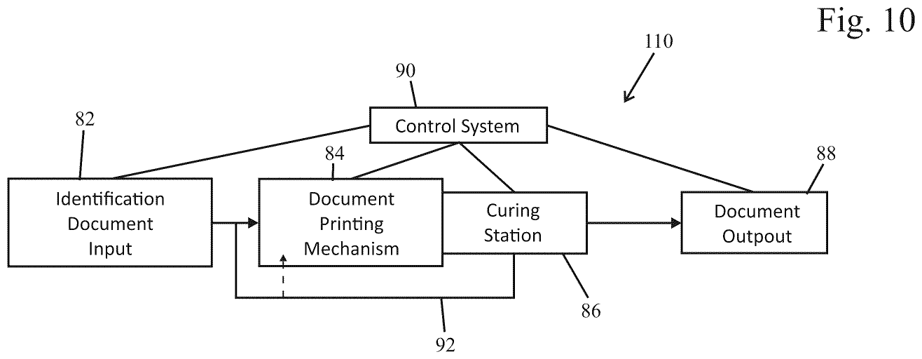

Referring to FIG. 10, another example of an identification document personalization system 110 that can implement the methods 10, 30 described in FIGS. 1-2 is illustrated. In FIG. 10, elements that are the same as or similar to elements in FIG. 8 are referenced using the same reference numerals. In FIG. 10, the system 110 includes the same elements as in the system 80 of FIG. 8. However, in FIG. 10, the printing mechanism 84 and the curing station 86 are depicted as being integrated together into the same physical structure as one another, rather than being separate structures as depicted in the system 80 in FIG. 8.

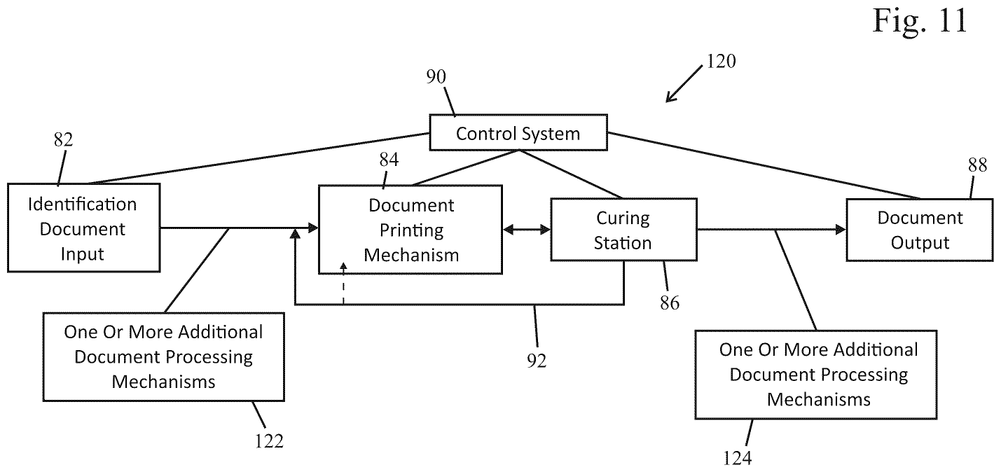

Referring to FIG. 11, another example of an identification document personalization system 120 that can implement the methods 10, 30 described in FIGS. 1-2 is illustrated. In FIG. 11, elements that are the same as or similar to elements in FIG. 8 are referenced using the same reference numerals. In FIG. 11, the system 120 includes the same elements as in the system 80 of FIG. 8. However, in FIG. 11, the system 120 is depicted as including optional one or more additional processing mechanisms 122 and optional one or more additional processing mechanisms 124. The optional additional processing mechanisms 122 may be located between the input 82 and the printing mechanism 84 and can include, but are not limited to, an embossing mechanism; an indenting mechanism; a laminating mechanism; a laser marking mechanism; a topcoat applicator; a security station that is configured to apply a security feature such as a holographic foil patch to the card; a flipping mechanism to flip the card 180 degrees; and other card processing mechanisms. The optional additional processing mechanisms 124 may be located between the curing station 86 and the output 88 and may include, but are not limited to, an embossing mechanism; an indenting mechanism; a laminating mechanism; a flipping mechanism to flip the card 180 degrees; a laser marking mechanism; a topcoat applicator; a quality control station that is configured to check the quality of personalization/processing applied to the card; a security station that is configured to apply a security feature such as a holographic foil patch to the card; and other card processing mechanisms.

The input 82 and the output 88 in the systems 80, 100, 110, 120 of FIGS. 8-11 can be positioned in the systems at any locations suitable for performing their input and output functions. For example, the input 82 can be located at the front end of the systems while the output 88 can be located at the tail end of the systems as shown in FIGS. 8-11. Alternatively, both the input 82 and the output 88 can be located at the same end of the systems, such as the front end (i.e. the end where the input 82 is located in FIGS. 8-11. Other locations of the input 82 and the output 88 in the systems of FIGS. 8-11 are possible.

The systems in FIGS. 8-11 maybe configured as large volume batch card personalization machines, often configured with multiple processing stations or modules, typically referred to as a central issuance system, that processes multiple cards or other documents at the same time and are designed to personalize documents in relatively large volumes, for example measured in the high hundreds or even thousands per hour. An example of a central issuance system is the MX or MPR-lines of central issuance systems available from Entrust Corporation of Shakopee, Minnesota. Additional examples of central issuance systems are disclosed in U.S. Pat. Nos. 4,825,054, 5,266,781, 6,783,067, and 6,902,107, all of which are incorporated herein by reference in their entirety. Alternatively, the systems in FIGS. 8-11 may be configured as desktop card or document printers that have a relatively small footprint intended to permit the desktop card printer to reside on a desktop and that is designed to personalize cards and other documents in relatively small volumes, for example measured in tens or low hundreds per hour. An example of a desktop card printer is the CD800 Card Printer available from Entrust Corporation of Shakopee, Minnesota. Additional examples of desktop card printers are disclosed in U.S. Pat. Nos. 7,434,728 and 7,398,972, each of which is incorporated herein by reference in its entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An identification document printing method in an identification document personalization system, comprising:
printing on a surface of the identification document with a radiation curable material;
partially curing the radiation curable material in a curing station by applying curing radiation from a cure lamp of the curing station to the radiation curable material;
thereafter printing on the surface of the identification document with additional radiation curable material;
thereafter fully curing the radiation curable material and the additional radiation curable material in the curing station by applying curing radiation from the cure lamp.

2. The identification document printing method in an identification document personalization system of claim 1, wherein the partially curing comprises using shutters in the curing station to control the amount of curing radiation emitted by the cure lamp from reaching the radiation curable material on the surface.

3. The identification document printing method in an identification document personalization system of claim 1, comprising emitting a first amount of curing radiation from the cure lamp during the partial curing and emitting a second amount of curing radiation from the cure lamp during the full curing, and the first amount is less than the second amount.

4. The identification document printing method in an identification document personalization system of claim 1, wherein the radiation curable material comprises an ink.

5. The identification document printing method in an identification document personalization system of claim 4, wherein the additional radiation curable material comprises a varnish or an ink.

6. The identification document printing method in an identification document personalization system of claim 1, wherein the curing radiation comprises ultraviolet radiation, and the cure lamp comprises at least one light emitting diode.

7. An identification document printing method in an identification document personalization system, comprising:
printing on a surface of the identification document with a radiation curable material;
partially curing the radiation curable material in a curing station by emitting a first level of curing radiation from a cure lamp of the curing station;
thereafter printing on the surface with additional radiation curable material;
thereafter fully curing the radiation curable material and the additional radiation curable material in the curing station by emitting a second level of curing radiation from the cure lamp of the curing station, the second level is greater than the first level.

8. The identification document printing method in an identification document personalization system of claim 7, wherein the radiation curable material comprises an ink.

9. The identification document printing method in an identification document personalization system of claim 8, wherein the additional radiation curable material comprises a varnish or an ink.

10. The identification document printing method in an identification document personalization system of claim 7, wherein the curing radiation comprises ultraviolet radiation, and the cure lamp comprises at least one light emitting diode.

11. An identification document personalization system, comprising:
a document input that inputs an identification document to be personalized;
an identification document printing mechanism downstream from the document input and configured to print radiation curable material on a surface of the identification document;
a curing station having at least one cure lamp;
a document output that receives the identification document after being personalized;
a control system that is connected to and configured to control operation of the identification document printing mechanism and the curing station; wherein the control system is configured to control the identification document printing mechanism to print a first radiation curable material on the surface of the identification document, control the curing station to partially cure the first radiation curable material by applying curing radiation from the at least one cure lamp to the first radiation curable material, thereafter control the identification document printing mechanism to print additional radiation curable material on the surface of the identification document, and thereafter control the curing station to fully cure the first radiation curable material and the additional radiation curable material in the curing station by applying curing radiation from the at least one cure lamp.

12. The identification document personalization system of claim 11, wherein the identification document printing mechanism comprises at least one drop-on-demand print head.

13. The identification document personalization system of claim 11, wherein the identification document printing mechanism comprises a plurality of drop-on-demand print heads.

14. The identification document personalization system of claim 11, wherein the at least one cure lamp comprises at least one light emitting diode.

15. The identification document personalization system of claim 11, wherein the identification document printing mechanism and the curing station are positioned between the document input and the document output.

16. An identification document personalization system, comprising:
a document input that inputs an identification document to be personalized;
a first identification document printing mechanism downstream from the document input and configured to print a first radiation curable material on a surface of the identification document;
a second identification document printing mechanism downstream from the document input and configured to print additional radiation curable material on the surface of the identification document;
a curing station having at least one cure lamp;
a document output that receives the identification document after being personalized;
a control system that is connected to and configured to control operation of the first identification document printing mechanism, the second identification printing mechanism, and the curing station; wherein the control system is configured to control the first identification document printing mechanism to print the first radiation curable material on the surface of the identification document, control the curing station to partially cure the first radiation curable material by applying curing radiation from the at least one cure lamp to the first radiation curable material, thereafter control the second identification document printing mechanism to print the additional radiation curable material on the surface of the identification document, and thereafter control the curing station to fully cure the first radiation curable material and the additional radiation curable material in the curing station by applying curing radiation from the at least one cure lamp.

17. The identification document personalization system of claim 16, wherein the first identification document printing mechanism and the second identification document printing mechanism each comprises at least one drop-on-demand print head.

18. The identification document personalization system of claim 16, wherein the first identification document printing mechanism and the second identification document printing mechanism each comprises a plurality of drop-on-demand print heads.

19. The identification document personalization system of claim 16, wherein the at least one cure lamp comprises at least one light emitting diode.

20. The identification document personalization system of claim 16, wherein the first identification document printing mechanism, the second identification document printing mechanism, and the curing station are positioned between the document input and the document output.
